(19) United States
(12) Patent Application Publication
(10) Pub. No.: US 2014/0191835 A1
(43) Pub. Date: Jul. 10, 2014

(54) MAGNETIC MATERIAL AND COIL COMPONENT EMPLOYING SAME

(71) Applicants: Hideki Ogawa, Nakanojou-machi (JP); Atsushi Tanada, Nakanojou-machi (JP)

(72) Inventors: Hideki Ogawa, Nakanojou-machi (JP); Atsushi Tanada, Nakanojou-machi (JP)

(73) Assignee: TAIYO YUDEN CO., LTD., Taito-ku, Tokyo (JP)

(21) Appl. No.: 14/129,520

(22) PCT Filed: Feb. 23, 2012
(86) PCT No.: PCT/JP2012/054439

§ 371 Date: Dec. 26, 2013

(30) Foreign Application Priority Data
Jul. 5, 2011 (JP) 2011-149579

(51) Int. Cl. H01F 1/40; H01F 27/28

(52) U.S. Cl. CPC H01F 1/408; H01F 27/28
USPC 336/177; 252/62.55; 252/62.54

(57) ABSTRACT

A magnetic material is constituted by a grain compact formed by compacting multiple metal grains that in turn are constituted by an Fe—Si-M soft magnetic alloy (where M is a metal element that oxidizes more easily than Fe), wherein individual metal grains have oxide film formed at least partially around them as a result of oxidization of the metal grains; the grain compact is formed primarily via bonding between oxide films formed around adjacent metal grains; and the apparent density of the grain compact 1 is 5.2 g/cm³ or more, or preferably 5.2 to 7.0 g/cm³.

### TECHNICAL FIELD

This application claims priority to Japanese Patent Application No. 2011-149579 filed in Japan on Jul. 5, 2011, the disclosure of which is incorporated herein by reference.

The present invention relates to a magnetic material used primarily as a core in a coil, inductor, etc., as well as a coil component using such magnetic material.

### BACKGROUND ART

Coil components such as inductors, choke coils and transformers (so-called inductance components) have a magnetic material and a coil formed inside or on the surface of the magnetic material. For the magnetic material, Ni—Cu—Zn ferrite or other type of ferrite is generally used.

There has been a need for these coil components of larger current capacity (higher rated current) in recent years, and switching the magnetic material from ferrite as traditionally used, to Fe—Cr—Si alloy, is being studied in order to meet such demand (refer to Patent Literature 1). Fe—Cr—Si alloy and Fe—Al—Si alloy have a higher saturated magnetic flux density than ferrite. On the other hand, their volume resistivity is much lower than that of ferrite.

Patent Literature 1 discloses a method of manufacturing the magnetic material part of a laminated coil component, which is to form magnetic layers using a magnetic paste containing Fe—Cr—Si alloy grains and glass component, laminate the magnetic layers with conductive patterns and sinter the laminate in a nitrogen ambience (reducing ambience), and then impregnate the sintered laminate with thermosetting resin.

Patent Literature 2 discloses a method of manufacturing complex magnetic material relating to a Fe—Al—Si pressed powder magnetic core used for choke coil, etc., where such manufacturing method involves pressure-compacting a mixture of alloy powder whose primary components are iron, aluminum and silicon on one hand, and binder on the other, and then heat-treating the pressure-compacted product in an oxidizing ambience.

Patent Literature 3 discloses a complex magnetic material that contains metal magnetic powder and thermosetting resin, where the metal magnetic powder has a specified packing factor and a specified value or higher of electrical resistivity.

### BACKGROUND ART LITERATURES

### Patent Literature

Patent Literature 1: Japanese Patent Laid-open No. 2007-027354

Patent Literature 2: Japanese Patent Laid-open No. 2001-11563

Patent Literature 3: Japanese Patent Laid-open No. 2002-305108

### SUMMARY OF THE INVENTION

### Problems to be Solved by the Invention

However, sintered products obtained by the manufacturing methods in Patent Literatures 1 to 3 do not always provide high magnetic permeability. Also, for inductors that utilize metal magnetic material, pressed powder magnetic cores made by compacting a mixture of metal magnetic material and binder are known. Commonly used pressed powder magnetic cores do not always provide high insulation resistance.

In consideration of the above, an object of the present invention is to provide a new magnetic material offering higher magnetic permeability, or preferably achieving such high magnetic permeability and high insulation resistance at the same time, and also provide a coil component that uses such magnetic material.

### Means for Solving the Problems

After studying in earnest, the inventors completed the present invention described below.

The magnetic material proposed by the present invention is constituted by a grain compact formed by compacting multiple metal grains that in turn are constituted by an Fe—Si-M soft magnetic alloy (where M is a metal element that oxidizes more easily than Fe). Here, individual metal grains have oxide film formed at least partially around them as a result of oxidization of the metal grains, and the grain compact is formed primarily via bonds between oxide films formed around adjacent metal grains. The apparent density of the grain compact is 5.2 g/cm³ or more, or preferably 5.2 to 7.0 g/cm³. The definition and measurement method of apparent density are described later.

Preferably the soft magnetic alloy is an Fe—Cr—Si alloy and the oxide film contains more elemental chromium than elemental iron in mol terms.

Preferably the grain compact has voids inside and polymer resin is impregnated in at least some of the voids.

According to the present invention, a coil component having the aforementioned magnetic material and a coil formed inside or on the surface of the magnetic material is also provided.

### Effects of the Invention

According to the present invention, a magnetic material offering high magnetic permeability and high mechanical strength is provided. In a preferred embodiment of the present invention, a magnetic material achieving high magnetic permeability, high mechanical strength, and high insulation resistance at the same time is provided. In another preferred embodiment of the present invention, high magnetic permeability, high mechanical strength, and moisture resistance are achieved at the same time, while in a more preferable embodiment, high magnetic permeability, high mechanical strength, high insulation resistance, and moisture resistance are all achieved at the same time. Here, moisture resistance refers to minimum drop in insulation resistance even at high humidity.

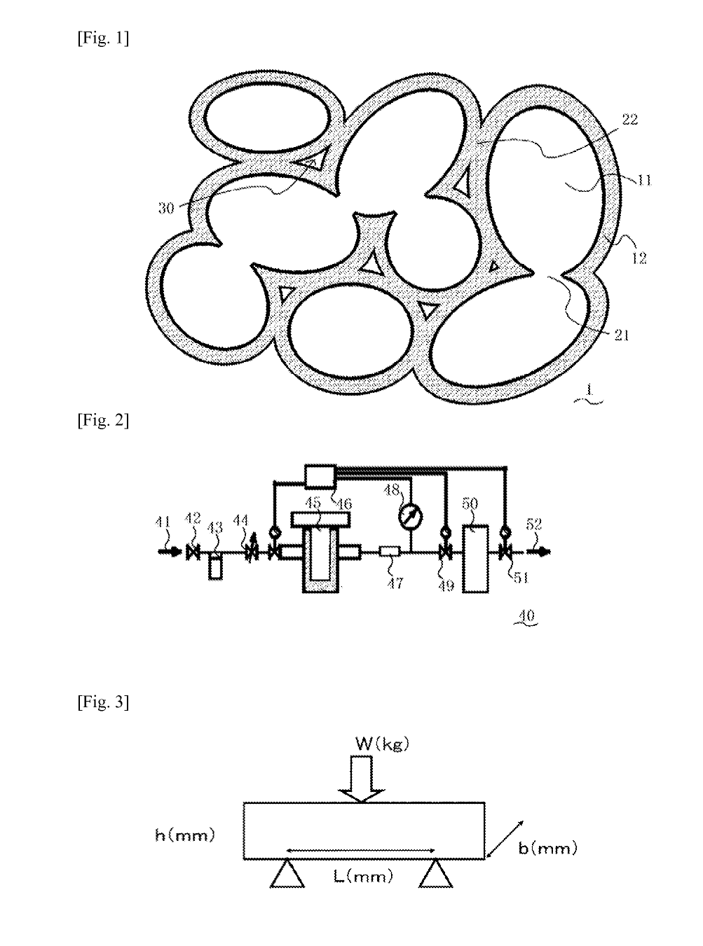

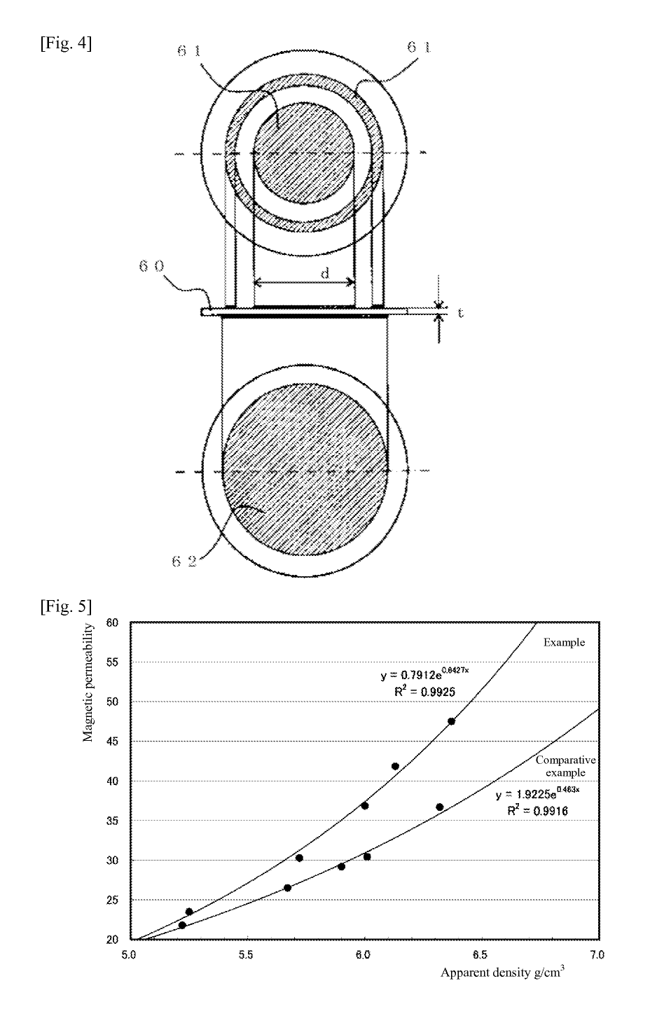

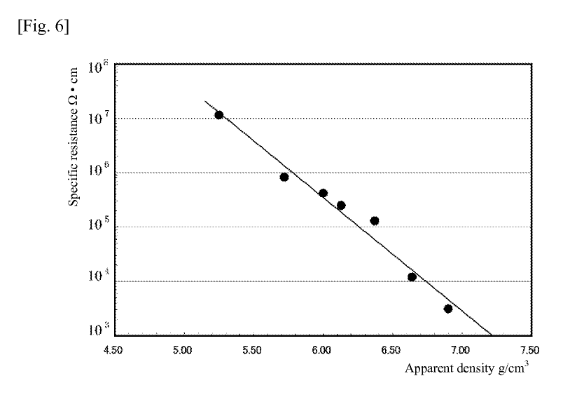

### BRIEF DESCRIPTION OF THE DRAWINGS

[FIG. 1] This is a section view providing a schematic illustration of the fine structure of a magnetic material conforming to the present invention.

[FIG. 2] This is a schematic diagram of a device that measures grain compact volume.

[FIG. 3] This is a schematic diagram explaining how 3-point flexural breaking stress is measured.

[FIG. 4] This is a schematic diagram explaining how specific resistance is measured.

[FIG. 5] This is a graph plotting magnetic permeability as a function of apparent density, showing the measured results of examples and comparative examples of the present invention.

[FIG. 6] This is a graph plotting specific resistance as a function of apparent density, showing the measured results of examples of the present invention.

### MODES FOR CARRYING OUT THE INVENTION

The present invention is described in detail by referring to the drawings as appropriate. It should be noted, however, that the present invention is not at all limited to the illustrated embodiments and that, because the characteristic parts of the invention may be emphasized in the drawings, the scale of each part of the drawings is not necessarily accurate.

According to the present invention, the magnetic material is constituted by a grain compact comprising specified grains aggregated in, for example, a rectangular solid or other specific shape.

Under the present invention, the magnetic material is what functions as a magnetic path in a coil, inductor or other magnetic component, and typically takes the form of a magnetic core of coil, etc.

FIG. 1 is a section view providing a schematic illustration of the fine structure of a magnetic material conforming to the present invention. Under the present invention, the grain compact 1 is understood microscopically as an aggregate of many originally independent metal grains 11 bonding together, where oxide film 12 is formed at least partially, or preferably almost completely, around individual metal grains 11 and this oxide film 12 ensures the insulation property of the grain compact 1. Adjacent metal grains 11 are bonded together, primarily by bonding together of the oxide films 12 formed around the respective metal grains 11, to constitute the grain compact 1 having a specific shape. Partially adjacent metal grains 11 can have bonds 21 between metals. Conventional magnetic materials use a hardened organic resin matrix in which single magnetic grains or bonds of several magnetic grains are dispersed, or a hardened glass component matrix in which single magnetic grains or bonds of several magnetic grains are dispersed. Under the present invention, preferably neither such organic resin matrix nor glass component matrix virtually exists.

The individual metal grains 11 are primarily constituted by specific soft magnetic alloy. Under the present invention, the metal grain 11 is constituted by an Fe—Si-M soft magnetic alloy. Here, M is a metal element that oxidizes more easily than Fe, and is typically Cr (chromium), Al (aluminum), Ti (titanium), etc., and preferably Cr or Al.

If the soft magnetic alloy is an Fe—Cr—Si alloy, the content of Si is preferably 0.5 to 7.0 percent by weight, or more preferably 2.0 to 5.0 percent by weight. A higher Si content is preferable as the resistivity and magnetic permeability become higher, while a lower Si content is associated with better formability. The preferable ranges mentioned above are proposed in consideration of the foregoing.

If the soft magnetic alloy is an Fe—Cr—Si alloy, the content of Cr is preferably 2.0 to 15 percent by weight, or more preferably 3.0 to 6.0 percent by weight. Presence of Cr is preferable in that it becomes passive state when treated with heat to suppress excessive oxidization and also express strength and insulation resistance, while less Cr is preferable from the viewpoint of improving magnetic characteristics. The preferable ranges mentioned above are proposed in consideration of the foregoing.

If the soft magnetic alloy is an Fe—Si—Al alloy, the content of Si is preferably 1.5 to 12 percent by weight. A higher Si content is preferable as the resistivity and magnetic permeability become higher, while a lower Si content is associated with better formability. The preferable range mentioned above is proposed in consideration of the foregoing.

If the soft magnetic alloy is an Fe—Si—Al alloy, the content of Al is preferably 2.0 to 8 percent by weight. The difference between Cr and Al is as follows. Fe—Si—Al provides higher magnetic permeability and volume resistivity, but is less strong, compared to Fe—Cr—Si of the same apparent density.

Note that the aforementioned preferred contents of respective metal components of soft magnetic alloy assume that the total quantity of alloy components gives 100 percent by weight. In other words, the preferred contents are calculated without considering the oxide film composition.

If the soft magnetic alloy is an Fe—Cr—M alloy, preferably the remainder of Si and M is Fe except for unavoidable impurities. Metals that may be contained in addition to Fe, Si and M include magnesium, calcium, titanium, manganese, cobalt, nickel, and copper, while non-metals that may be contained include phosphorous, sulfur and carbon.

The chemical composition of the alloy constituting each metal grain 11 of the grain compact 1 can be calculated, for example, by capturing a section of the grain compact 1 with a scanning electron microscope (SEM) and then analyzing the obtained image according to the ZAF method based on energy-dispersive X-ray spectroscopy (EDS).

The magnetic material proposed by the present invention can be manufactured by compacting metal grains constituted by any specified soft magnetic alloy mentioned above and then heat-treating the metal grains. At this time, preferably heat treatment is applied in such a way that, in addition to the oxide film the material metal grains (hereinafter also referred to as “material grains”) already have, some metal parts of material metal grains are oxidized to form oxide film 12. This means that, under the present invention, oxide film 12 is formed primarily by oxidization of the surface of metal grains 11. In a preferred embodiment, oxides other than those formed by oxidization of metal grains 11, such as silica and phosphate compounds, for example, are not included in the magnetic material proposed by the present invention.

Individual metal grains 11 constituting the grain compact 1 have oxide film 12 formed around them. Oxide film 12 may be formed in the material grain stage before the grain compact 1 is formed, or oxide film may be generated in the compaction process by keeping oxide film non-existent or extremely little in the material grain stage. Presence of oxide film 12 can be recognized by contrast (brightness) difference on an image taken by a scanning electron microscope (SEM) at a magnification of 3000 times or so. Presence of oxide film 12 assures insulation property of the magnetic material as a whole.

Preferably the oxide film 12 contains more metal element M than elemental iron in mol terms. One way to obtain oxide film 12 of such constitution is to make sure the material grains for magnetic material contain as little iron oxide as possible or keep the content of iron oxide to the absolute minimum, and oxidize the surface of the alloy by means of heat treatment, etc., during the process of obtaining the grain compact 1. When heat treatment, etc., is applied this way, metal M that oxidizes more easily than iron is selectively oxidized and consequently the mol ratio of metal M in the oxide film 12 becomes relatively higher than that of iron. One advantage of the oxide film 12 containing more metal element M than elemental iron is that excessive oxidization of alloy grains is suppressed.

The method of measuring the chemical composition of the oxide film 12 in the grain compact 1 is as follows. First, the grain compact 1 is fractured or otherwise its cross section is exposed. Next, the cross section is smoothed by means of ion milling, etc., and then captured with a scanning electron microscope (SEM), followed by composition calculation of the oxide film 12 according to the ZAF method based on energy dispersive X-ray spectroscopy (EDS).

The content of metal M in oxide film 12 is preferably 1.0 to 5.0 mol, or more preferably 1.0 to 2.5 mol, or even more preferably 1.0 to 1.7 mol, per 1 mol of Fe. Any higher content is preferable in terms of suppressing excessive oxidization, while any lower content is preferable in terms of sintering the space between metal grains. Methods to increase the content includes heat-treating in a weak oxidizing ambience, for example, while the methods to increase the content includes heat-treating in a strong oxidizing ambience, for example.

In the grain compact 1, bonds between grains are primarily bonds 22 between oxide films 12. Presence of bonds 22 between oxide films 12 can be clearly determined by, for example, visually identifying on a SEM-observed image enlarged to approx. 3000 times, etc., that the oxide films 12 on adjacent metal grains 11 have the same phase. Presence of bonds 22 between oxide films 12 improves mechanical strength and insulation property. Preferably oxide films 12 on adjacent metal grains 11 are bonded together over the entire grain compact 1, but mechanical strength and insulation property will improve to some extent so long as they are bonded at least partially, and this pattern is also considered an embodiment of the present invention. Favorably the number of bonds 22 between oxide films 12 is equal to or greater than the number of metal grains 11 contained in the grain compact 1. Also, as described later, bonding 21 between metal grains 11 that does not involve bonding between oxide films 12 may be present in some parts. Furthermore, a mode (not illustrated) where adjacent metal grains 11 are only physically contacting or in close proximity with each other in the absence of bonding between oxide films 12 or bonding between metal grains 11 may be present in some parts.

Methods to generate bonds 22 between oxide films 12 include, for example, applying heat treatment at the specified temperature described later in an ambience where oxygen is present (such as air) when the grain compact 1 is manufactured.

According to the present invention, not only bonds 22 between oxide films 12 but bonds 21 between metal grains 11 may be present in the grain compact 1. In the same manner with bonds 22 between oxide films 12 as mentioned above, presence of bonds 21 between metal grains 11 can be clearly determined by, for example, visually confirming on a SEM-observed image enlarged to approx. 3000 times, etc., that adjacent metal grains 11 have the same phase as well as bonding points. Presence of bonds 21 between metal grains 11 improves magnetic permeability further.

Methods to generate bonding parts 21 where metal grains 11 are bonded directly together include, for example, using material grains having less oxide film on them, adjusting the temperature and partial oxygen pressure as described later during the heat treatment needed to manufacture the grain compact 1, and adjusting the compacting density at which to obtain the grain compact 1 from the material grains. It can be proposed that the heat treatment temperature is enough to bond the metal grains 11 together, while keeping the generation of oxide to a minimum. The specific preferable temperature ranges are mentioned later. The partial oxygen pressure may be that in air, for example, and the lower the partial oxygen pressure, the less likely the generation of oxide becomes and consequently the more likely the metal-to-metal bonding of metal grains 11 becomes.

According to the present invention, the grain compact 1 has a specified apparent density. The apparent density represents the weight of the grain compact 1 per unit volume. The apparent density is different from the characteristic density of the substance constituting the grain compact 1 and, for example, presence of voids 30 in the grain compact 1 leads to a lower apparent density. The apparent density is dependent on the characteristic density of the very substance constituting the grain compact 1, and also on the denseness of arrangement of metal grains 11 when the grain compact 11 is formed.

The apparent density of the grain compact 1 is 5.2 g/cm³ or more, or preferably 5.2 to 7.0 g/cm³, or more preferably 5.6 to 6.9 g/cm³, or most preferably 6.0 to 6.7 g/cm³. An apparent density of 5.2 g/cm³ or more improves magnetic permeability, while an apparent density of 7.0 g/cm³ or less achieves high magnetic permeability and high insulation resistance at the same time.

The measurement method of apparent density is described below.

First, the compact volume V_{P} is measured by the “Gas Replacement Method” according to JIS R1620-1995. For the measuring device, the Ultrapycnometer 1000 by Quantachrome Instruments can be used, for example. FIG. 2 is a schematic diagram of a device that measures compact volume. With this measuring device 40, gas (typically helium gas) is introduced as indicated by an arrow 41, after which the gas travels through a valve 42, safety valve 43 and flow rate control valve 44, passes through a sample chamber 45, and travels further through a filter 47 and solenoid valve 49, before entering a comparison chamber 50. Thereafter, the gas is released from the measurement system via a solenoid valve 51 as indicated by another arrow 52. The device 40 is equipped with a pressure gauge 48 and is controlled by a CPU 46.

Here, the volume V_{P} of the compact being measured is calculated as follows:

V_{P}=V_{C}−V_{A}/{(p₁/p₂)−1}

Note that V_{C} represents the volume of the sample chamber 45, V_{A} represents the volume of the comparison chamber 50, p₁ represents the internal pressure of the system when the sample chamber 45 is pressurized to the atmospheric pressure or above with a sample placed inside, and p₂ represents the internal pressure of the system resulting from opening the solenoid valve 49 when the internal pressure is p₁.

Once the volume V_{P} of the compact has been measured as above, the next step is to measure the mass M of the compact using an electronic balance. The apparent density is calculated as M/V_{P}.

Under the present invention, the material system that constitutes the grain compact 1 is roughly fixed, so the apparent density is primarily controlled by the denseness of arrangement of metal grains 11. The apparent density can be increased primarily by making the arrangement of metal grains 11 denser, while it can be decreased primarily by making the arrangement of metal grains 11 sparser, for example. With the material system used by the present invention, the apparent density is expected to become approx. 5.6 g/cm³ when the individual metal grains 11 are assumed to be spherical and packed to the maximum density. To increase the apparent density further, large grains and small grains can be mixed as metal grains 11 so that small grains fill the voids 30 in the large-grain packed structure. The apparent density can be adjusted as deemed appropriate by referencing the results of examples described later, for example, for specific control methods.

According to one preferred embodiment, the material grains mentioned later are prepared by mixing material grains whose d50 is 10 to 30 μm and Si content is 2 to 4 percent by weight, with material grains whose d50 is 3 to 8 μm and Si content is 5 to 7 percent by weight. This way, the relatively larger material grains of relatively lower Si content undergo plastic deformation when pressurized, and the relatively smaller grains of relatively higher Si content fill the gaps between these relatively large grains, and consequently the apparent density improves.

According to another preferred embodiment, material grains whose d50 is 10 to 30 μm and Si content is 5 to 7 percent by weight are combined with material grains whose d50 is 3 to 8 μm and Si content is 2 to 4 percent by weight.

According to yet another preferred embodiment, the pressure mentioned later which is applied to the material grains when they are compacted, prior to heat treatment, is increased to improve the apparent density, where such higher pressure is specifically 1 to 20 t/cm², for example, or preferably 3 to 13 t/cm².

According to yet another preferred embodiment, the temperature mentioned later at which the material grains are compacted, prior to heat treatment, is adjusted to a specified range to control the apparent density. To be specific, the higher the temperature, the more the apparent density improves. Specific temperatures are 20 to 120° C., or preferably 25 to 80° C., for example, and preferably the aforementioned pressures are applied at temperatures in these ranges to perform compaction.

According to yet another preferred embodiment, the amount of the lubricant mentioned later that can be applied during compaction (prior to heat treatment) is adjusted to control the apparent density. The apparent density of the grain compact 1 increases when the amount of lubricant is adjusted to an appropriate level. Specific amounts of lubricant are mentioned later.

For the metal grains (material grains) used as the material for manufacturing the magnetic material proposed by the present invention, preferably grains constituted by an Fe-M-Si alloy, or more preferably grains constituted by an Fe—Cr—Si alloy, are used. The alloy composition of the material grains is reflected in the alloy composition of the magnetic material finally obtained. Accordingly, a desired alloy composition can be selected for the material grains as deemed appropriate according to the alloy composition of the magnetic material to be finally obtained, where preferred composition ranges for the material grains are the same as the preferred composition ranges for the magnetic material as mentioned earlier. Individual material grains may be covered with oxide film. In other words, individual material grains may be constituted by specified soft magnetic alloy at the center as well as oxide film formed at least partially around the soft magnetic alloy as a result of oxidization of the soft magnetic alloy.

The sizes of individual material grains are virtually equal to the sizes of grains constituting the grain compact 1 in the magnetic material finally obtained. Considering the magnetic permeability and in-grain eddy current loss, the material grain size is preferably 2 to 30 μm, or more preferably 2 to 20 μm, or most preferably 3 to 13 μm, in terms of d50. The d50 of the material grain can be measured using a measuring device that uses laser diffraction/scattering. In addition, the d10 is preferably 1 to 5 μm, or more preferably 2 to 5 μm. Furthermore, the d90 is preferably 4 to 30 μm, or more preferably 4 to 27 μm. Preferred embodiments using material grains of different sizes to control the apparent density of the grain compact 1 are given below.

The first preferred embodiment is to mix 10 to 30 percent by weight of material grains whose d50 is 5 to 8 μm, with 70 to 90 percent by weight of material grains whose d50 is 9 to 15 μm.

For controlling the apparent density of the grain compact 1 by mixing material grains of different grain sizes, Example 3 and Example 9 mentioned later can be referenced, for example.

The second preferred embodiment is to mix 8 to 25 percent by weight of material grains whose d50 is 6 to 10 μm, with 75 to 92 percent by weight of material grains whose d50 is 12 to 25 μm.

Material grains may be those manufactured by the atomization method, for example. As mentioned earlier, bonds 22 via oxide film 12 are present in the grain compact 1 and therefore preferably oxide film is present on the material grains.

The ratio of metal and oxide film in the material grain can be quantified as follows. The material grain is analyzed by XPS by focusing on the peak intensity of Fe, and the integral value of peaks at which Fe exists as metal (706.9 eV), or Fe_{Metal}, and integral value of peaks at which Fe exists as oxide, or Fe_{Oxide}, are obtained, after which Fe_{Metal} (Fe_{Metal}+Fe_{Oxide}) is calculated to quantify the ratio. Here, the calculation of Fe_{Oxide} involves fitting with the measured data based on normal distribution layering around the binding energies of three types of oxides, namely Fe₂O₃ (710.9 eV), FeO (709.6 eV) and Fe₃O₄ (710.7 eV). As a result, Fe_{Oxide} is calculated as the sum of integral areas isolated by peaks. Preferably the above value is 0.2 or greater from the viewpoint of enhancing the magnetic permeability as a result of promoting the generation of bonds 21 between metals during heat treatment. The upper limit of the above value is not specified in any way, but it can be 0.6, for example, from the viewpoint of manufacturing ease, and a preferable upper limit is 0.3. Methods to raise the above value include heat-treating the material grains in a reducing ambience prior to compaction, removing the surface oxide layer using acid or applying other chemical treatment, for example.

For the aforementioned material grain, any known alloy grain manufacturing method may be adopted, or PF20-F by Epson Atmix, SFR-FeSiAl by Nippon Atomized Metal Powders or other commercial product may be used. If a commercial product is used, it is highly likely that the aforementioned value of Fe_{Metal}/(Fe_{Metal}+Fe_{Oxide}) is not considered and therefore it is preferable to screen material grains or apply the aforementioned heat treatment, chemical treatment, or other pretreatment.

The method to obtain a compact from the material grain is not limited in any way, and any known means for grain compact manufacturing can be adopted as deemed appropriate. The following explains a typical manufacturing method of compacting the material grains under non-heating conditions and then applying heat treatment. However, the present invention is not at all limited to this manufacturing method.

When compacting the material grains under non-heating conditions, it is preferable to add organic resin as binder. For the organic resin, it is preferable to use one constituted by PVA resin, butyral resin, vinyl resin, or other resin whose thermal decomposition temperature is 500° C. or below, as less binder will remain after the heat treatment. Any known lubricant may be added at the time of compacting. The lubricant may be organic acid salt, etc., where specific examples include zinc stearate and calcium stearate. The amount of lubricant is preferably 0 to 1.5 parts by weight, or more preferably 0.1 to 1.0 part by weight, or most preferably 0.15 to 0.45 part by weight, or particularly preferably 0.15 to 0.25 part by weight, relative to 100 parts by weight of material grains. When the amount of lubricant is 0, it means lubricant is not used at all. After adding binder and/or lubricant to the material grains as desired, the mixture is agitated and then compacted to a desired shape. At the time of compaction, 2 to 20 t/cm² of pressure may be applied, for example, or the compaction temperature may be adjusted to 20 to 120° C., for example.

A preferred embodiment of heat treatment is explained.

Preferably heat treatment is performed in an oxidizing ambience. To be more specific, the oxygen concentration is preferably 1% or more during heating, as it promotes the generation of both bonds 22 between oxide films and bonds 21 between metals. Although the upper limit of oxygen concentration is not specified in particular, the oxygen concentration in air (approx. 21%) may be used, for example, in consideration of manufacturing cost, etc. The heating temperature is preferably 600° C. or above from the viewpoint of generating oxide film 12 and thereby promoting the generation of bonds between oxide films 12, and 900° C. or below from the viewpoint of suppressing oxidization to an appropriate level in order to maintain the presence of bonds 21 between metals and thereby enhance magnetic permeability. More preferably the heating temperature is 700 to 800° C. Preferably the heating time is 0.5 to 3 hours from the viewpoint of promoting the generation of both bonds 22 between oxide films 12 and bonds 21 between metals. The mechanism by which bonds via oxide film 12 and bonds 21 between metal grains generate is considered similar to the mechanism of so-called ceramics sintering in a high temperature range of approx. 600° C. or above, for example. That is to say, according to the new knowledge gained by the inventors, it is important in this heat treatment that (A) oxide film comes in full contact with an oxidizing ambience while metal elements are supplied from metal grains as needed so that the oxide film itself will grow, and that (B) adjacent oxide films contact each other directly to allow for inter-diffusion of the substances constituting the oxide films. Accordingly, preferably thermosetting resins, silicone and other substances that may remain in a high-temperature range of 600° C. or above are virtually non-existent during heat treatment.

The obtained grain compact 1 may have voids 30 inside. Polymer resin (not illustrated) may be impregnated in at least some of the voids 30 present inside the grain compact 1. Methods to impregnate polymer resin include, for example, soaking the grain compact 1 in polymer resin in liquid state, solution of polymer resin or other liquefied polymer resin and then lowering the pressure of the manufacturing system, or applying the aforementioned liquefied polymer resin onto the grain compact 1 and letting it seep into the voids 30 near the surface. Impregnating polymer resin in the voids 30 in the grain compact 1 is beneficial in that it increases strength and suppresses hygroscopic property, which specifically means that moisture does not enter the grain compact 1 easily at high humidity and consequently insulation resistance does not drop easily. The polymer resin is not limited in any way and may be epoxy resin, fluororesin or other organic resin, or silicone resin, among others.

The grain compact 1 thus obtained exhibits high magnetic permeability of 20 or more, for example, or preferably 30 or more, or more preferably 35 or more, as well as flexural breaking strength (mechanical strength) of 4.5 kgf/mm² or more, for example, or preferably 6 kgf/mm² or more, or more preferably 8.5 kgf/mm² or more, and in a preferred embodiment, it also exhibits high specific resistivity of 500 Ω·cm or more, for example, or preferably 10³ Ω·cm or more.

According to the present invention, the magnetic material constituted by such grain compact 1 can be used as a constituent of various electronic components. For example, the magnetic material conforming to the present invention may be used as a core, with an insulating sheathed conductive wire wound around it, to form a coil. Or, green sheets containing the aforementioned material grains may be formed using any known method, followed by printing or otherwise applying a conductive paste onto the green sheets in a specific pattern and then laminating the printed green sheets and pressurizing the laminate, followed further by heat treatment under the aforementioned conditions, to obtain an inductor (coil component) having a coil formed inside the grain-compact magnetic material conforming to the present invention. In addition, various coil components may be obtained by forming a coil inside or on the surface of the magnetic material conforming to the present invention. The coil component can be any of the various mounting patterns such as surface mounting and through hole mounting, and for the means to obtain a coil component from the magnetic material, including the means to constitute the coil component of any such mounting pattern, any known manufacturing method in the electronics component field may be adopted as deemed appropriate.

### EXAMPLES

The present invention is explained specifically below using examples. It should be noted, however, that the present invention is not at all limited to the embodiments described in these examples.

### Examples 1 to 7

### (Material Grain)

A commercial alloy powder manufactured by the atomization method, having a composition of 4.5 percent by weight of Cr, 3.5 percent by weight of Si and Fe constituting the remainder, and grain size distribution of d50 being 10 μm, d10 being 4 μm and d90 being 24 μm, was used as the material grain. An aggregate surface of this alloy powder was analyzed by XPS and the aforementioned Fe_{Metal}/(Fe_{Metal}+Fe_{Oxide}) was calculated as 0.5.

### (Manufacturing of Grain Compact)

One hundred parts by weight of material grains thus prepared were mixed under agitation with 1.5 parts by weight of PVA binder whose thermal decomposition temperature is 300° C., after which 0.2 part by weight of zinc stearate was added as lubricant. Then, the mixture was compacted at each temperature specified in Table 1 and each pressure specified in Table 1, after which the compact was heat-treated at 750° C. for 1 hour in an oxidizing ambience of 21% in oxygen concentration, to obtain a grain compact.

### Example 8

A commercial alloy powder manufactured by the atomization method, having a composition of 5.5 percent by weight of Al, 9.7 percent by weight of Si and Fe constituting the remainder, and grain size distribution of d50 being 10 μm, d10 being 3 μm and d90 being 27 μm, was used as the material grain, which was processed in the same manner as in Example 1, to obtain a grain compact. However, the compaction temperature and compaction pressure prior to heat treatment were changed as shown in Table 1.

### (Evaluation)

Each obtained grain compact was measured for apparent density, magnetic permeability, specific resistance and 3-point flexural breaking strength, respectively. FIG. 3 is a schematic diagram explaining how 3-point flexural breaking strength was measured. Load was applied, as shown, to the measuring target (sheet-shaped grain compact of 50 mm in length, 10 mm in width and 4 mm in thickness) and the load W at which the measuring target broke was measured. The 3-point flexural breaking stress σ was calculated according to the formula below by considering the bending moment M and geometrical moment of inertia I:

σ=(M/I)×(h/2)=3WL/2bh²

Magnetic permeability was measured as follows. A coil constituted by urethane sheathed copper wire of 0.3 mm in diameter was wound around each obtained grain compact (toroidal shape of 14 mm in outer diameter, 8 mm in inner diameter and 3 mm in thickness) 20 turns to obtain a test sample. Saturated magnetic flux density Bs was measured using a vibrating sample magnetometer (VSM manufactured by Toei Industry), while magnetic permeability μ was measured at a measurement frequency of 100 kHz using a LCR meter (4285A manufactured by Agilent Technologies).

Specific resistance was measured according to JIS-K6911 as follows. FIG. 4 is a schematic diagram explaining how specific resistance was measured. A disc-shaped test piece 60 whose surface electrode 61 had an inner circle of outer diameter d, and which had a diameter of 100 mm and thickness t (=0.2 cm), was measured for volume resistance Rᵥ (Ω), and specific resistance (volume resistivity) ρᵥ (Ωcm) was calculated according to the formula below:

ρᵥ=πd²Rᵥ/(4t)

When the grain compacts in Examples 1 to 8 were SEM-observed (at 3000 times), oxide film 12 was formed around individual metal grains 11 and a majority of metal grains 11 had bonds between oxide films 12 with adjacent metal grains 11, confirming that the grain compact 1 as a whole had a virtually continuous structure.

The manufacturing conditions and measured results of Examples 1 to 8 are summarized in Table 1.

TABLE 1

| | Compaction | Compaction | Apparent | | Specific | Flexural breaking |
|---|---|---|---|---|---|---|
| | temperature | pressure | density | Magnetic | resistance | strength |
| | ° C. | ton/cm² | g/cm³ | permeability | ×10⁵Ω · cm | kgf/mm² |
| Example 1 | 25 | 2 | 5.25 | 23.5 | 120 | 5.1 |
| Example 2 | 25 | 4 | 5.72 | 30.3 | 8.3 | 6.4 |
| Example 3 | 25 | 6 | 6.00 | 36.8 | 4.2 | 9.0 |
| Example 4 | 25 | 9 | 6.13 | 41.8 | 2.5 | 10.7 |
| Example 5 | 25 | 12 | 6.37 | 47.5 | 1.3 | 13.6 |
| Example 6 | 80 | 12 | 6.64 | 56.3 | 0.12 | 16.3 |
| Example 7 | 80 | 20 | 6.90 | 71.2 | 0.03 | 18.7 |
| Example 8 | 80 | 12 | 5.28 | 44.3 | 58 | 4.8 |

### Comparative Examples 1 to 6

One hundred parts by weight of material grains of the same type used in Example 1 were mixed under agitation with 2.4 parts by weight of liquid epoxy resin mixture, to which 0.2 part by weight of zinc stearate was added as lubricant. The liquid epoxy resin mixture was constituted by 100 parts by weight of epoxy resin, 5 parts by weight of curing agent, 0.2 parts by weight of imidazole catalyst, and 120 parts by weight of solvent. Thereafter, the mixture was compacted to a specified shape at 25° C. and each pressure specified in Table 2, and then heat-treated for approx. 1 hour at 150° C. to cure the epoxy resin, to obtain each of the grain compacts of Comparative Examples 1 to 5. Separately, 100 parts by weight of material grains of the same type used in Example 8 were mixed under agitation with 2.4 parts by weight of the liquid epoxy resin mixture of the aforementioned composition, to which 0.2 parts by weight of zinc stearate was added as lubricant. Thereafter, the mixture was compacted to a specified shape at 25° C. and the pressure specified in Table 2, and then heat-treated for approx. 1 hour at 150° C. to cure the epoxy resin, to obtain the grain compact of Comparative Example 6. In other words, Comparative Examples 1 to 6, where heat treatment at 600° C. or above was omitted, each produced a material corresponding to a so-called metal composite as heretofore known, which was specifically constituted by a matrix of cured epoxy resin in which lubricant and metal grains were mixed together, where adjacent metal grains virtually had no bonding between oxide films or bonding between metals. The manufacturing conditions and measured results of Comparative Examples 1 to 6 are summarized in Table 2.

TABLE 2

| | Compaction | Compaction | Apparent | |
|---|---|---|---|---|
| | temperature | pressure | density | Magnetic |
| | ° C. | ton/cm² | g/cm³ | permeability |
| Comparative | 25 | 2 | 5.22 | 21.8 |
| Example 1 | | | | |
| Comparative | 25 | 5 | 5.67 | 26.5 |
| Example 2 | | | | |
| Comparative | 25 | 8 | 5.90 | 29.2 |
| Example 3 | | | | |
| Comparative | 25 | 12 | 6.01 | 30.4 |
| Example 4 | | | | |
| Comparative | 25 | 15 | 6.32 | 36.7 |
| Example 5 | | | | |
| Comparative | 25 | 12 | 5.25 | 37.2 |
| Example 6 | | | | |

FIG. 5 is a graph plotting magnetic permeability as a function of apparent density, showing the measured results of Examples 1 to 5 and Comparative Examples 1 to 5. When x represents apparent density and y represents magnetic permeability, Examples 1 to 5 had an approximation expression of y=0.7912e^{0.6427x} (R²=0.9925), while Comparative Examples 1 to 5 had an approximation expression of y=1.9225e^{0.463x} (R²=0.9916). As shown in FIG. 5, the grain compacts conforming to the present invention, containing no binder and having an apparent density of 5.2 or more, exhibited markedly higher levels of magnetic permeability compared to the conventional metal composites.

Note that, with Example 5, a section of the grain compact was captured with a scanning electron microscope (SEM) and the composition was calculated according to the ZAF method based on energy-dispersive X-ray spectroscopy (EDS), as mentioned earlier, to perform element analysis of oxide film. As a result, the oxide film contained 1.6 mols of chromium per 1 mol of iron.

FIG. 6 is a graph plotting specific resistance as a function of apparent density, showing the measured results of Examples 1 to 7. Clearly the grain compacts whose apparent density was 7.0 g/cm³ or less had a sufficiently high specific resistance of 500 Ω·cm or more.

### Example 9

A mixed powder consisting of 15 percent by weight of an alloy powder having the same chemical composition as the powder used in Examples 1 to 7 and d50 of 5 μm, and 85 percent by weight of alloy grains having the same chemical composition as the alloy grains used in Examples 1 to 7 and d50 of 10 μm, was used as the material grains, which were processed in the same manner as in Example 3 to obtain a grain compact with an apparent density of 6.27 g/cm³. A comparison of Examples 3 and 9 found that a grain compact of higher apparent density could be obtained by replacing some of material grains with grains of smaller size.

### DESCRIPTION OF THE SYMBOLS

1: Grain compact, 11: Metal grain, 12: Oxide film, 21: Bond between metals, 22: Bond between oxide films, 30: Void, 40: Device that measures compact volume, 45: Sample chamber, 46: CPU, 50: Comparison chamber

1. A magnetic material constituted by a grain compact formed by compacting multiple metal grains that are constituted by an Fe—Si-M soft magnetic alloy (where M is a metal element that oxidizes more easily than Fe);
wherein individual metal grains have oxide film formed at least partially around them as a result of oxidization of the metal grains;
wherein the grain compact is formed primarily via bonding between oxide films formed around adjacent metal grains; and
wherein an apparent density of the grain compact as expressed by M/V_{P} is 5.2 g/cm³ or more, where M represents a mass of the grain compact sample, while V_{P} represents a volume of the grain compact sample as measured by a gas replacement method.

2. A magnetic material according to claim 1, wherein the soft magnetic alloy is an Fe—Cr—Si alloy, and the oxide film contains more elemental chromium than elemental iron in mol terms.

3. A magnetic material according to claim 1, wherein the apparent density M/V_{P} of the grain compact is 7.0 g/cm³ or less.

4. A magnetic material according to claim 1, wherein the grain compact has voids inside, and polymer resin is impregnated in at least some of the voids.

5. A coil component having the magnetic material according to claim 1, and a coil formed on a surface of or inside the magnetic material.

6. A magnetic material according to claim 2, wherein the apparent density M/V_{P} of the grain compact is 7.0 g/cm³ or less.

7. A magnetic material according to claim 2, wherein the grain compact has voids inside, and polymer resin is impregnated in at least some of the voids.

8. A magnetic material according to claim 3, wherein the grain compact has voids inside, and polymer resin is impregnated in at least some of the voids.

9. A magnetic material according to claim 6, wherein the grain compact has voids inside, and polymer resin is impregnated in at least some of the voids.

10. A coil component having the magnetic material according to claim 2, and a coil formed on a surface of or inside the magnetic material.

11. A coil component having the magnetic material according to claim 3, and a coil formed on a surface of or inside the magnetic material.

12. A coil component having the magnetic material according to claim 4, and a coil formed on a surface of or inside the magnetic material.

13. A coil component having the magnetic material according to claim 6, and a coil formed on a surface of or inside the magnetic material.

14. A coil component having the magnetic material according to claim 7, and a coil formed on a surface of or inside the magnetic material.

15. A coil component having the magnetic material according to claim 8, and a coil formed on a surface of or inside the magnetic material.

16. A coil component having the magnetic material according to claim 9, and a coil formed on a surface of or inside the magnetic material.
